(19) United States
(12) Patent Application Publication
(10) Pub. No.: US 2016/0347112 A1
(43) Pub. Date: Dec. 1, 2016

(54) Dry Erase Board

(71) Applicant: Max Creative Industrial Limited, Kowloon (HK)

(72) Inventor: Chick Ting Eddie Chow, Kowloon (HK)

(73) Assignee: MAX CREATIVE INDUSTRIAL LIMITED, Kowloon (HK)

(21) Appl. No.: 14/722,865

(22) Filed: May 27, 2015

(51) Int. Cl. B43L 1/00

(52) U.S. Cl. CPC B43L 1/00

(57) ABSTRACT

A dry erase board, comprising a platy main body and a PVC adhesive tape mounted on the main body, wherein the main body includes a white board and a corrugated paper board affixed on a rear surface of the white board; a fore end portion and an aft end portion of the PVC adhesive tape mounted on the main body are connected to each other to form a plastic frame. Since the corrugated paper board is adopted to serve as the support body of the main body of the dry erase board, the weight of the dry erase board can be reduced greatly to make the dry erase board convenient to carry. The present application has a simple structure and strong practicality.

### TECHNICAL FIELD

The application relates to a field of office products, and more particularly relates to a dry erase board.

### BACKGROUND

Recently, a dry erase board, serving as a teaching tool, having advantages of non-pollution and convenience to use, etc., has received more and more attention and has been used more. However, the size of the existing dry erase board is larger, the weight is heavier, and the dry erase board is usually fixed on a wooden support, and is not convenient to carry.

### SUMMARY

The objective of the present application is to provide a dry erase board that has a light weight and is easy to carry, aiming at the defects that the size of an existing dry erase board is larger, the weight is heavier, and the dry erase board is usually fixed on a wooden support, which is not convenient to carry.

The technical solutions of the present application for solving the technical problems are as follows:

In one aspect, a dry erase board comprising a platy main body and a PVC adhesive tape mounted on the main body is provided; the main body includes a white board and a corrugated paper board affixed on a rear surface of the white board; a fore end portion and an aft end portion of the PVC adhesive tape mounted on the main body are connected to each other to form a plastic frame.

In one embodiment, the fore end portion and the aft end portion of the PVC adhesive tape are connected to each other via an adhesion agent.

In another embodiment, the dry erase board further includes a shackle; the shackle is respectively shackled on the two end portions of the PVC adhesive tape, in such a way that the two end portions of the PVC adhesive tape are connected to each other via the shackle.

In another embodiment, a cross section of the shackle is H-shaped, and the shackle has a bottom fixing recess and a top fixing recess configured for fastening a dry erase board pen; two fixing flanges are respectively formed on two internal surfaces in the bottom fixing recess of the shackle; the shackle are respectively shackled on the two end portions of the PVC adhesive tape via the bottom fixing recess and the two fixing flanges.

In another embodiment, an accommodating recess is formed in an internal surface of the PVC adhesive tape, and an edge portion of the main body is fastened in the accommodating recess.

In another embodiment, the white board is a white organic glass panel or a white PVC panel.

The present application adopts the corrugated paper board to serve as a support body of a main body of the dry erase board and then adopts a PVC adhesive tape and glue to edge-seal the corrugated paper board, in such a way that he corrugated paper board is hard to fold. Since the corrugated paper board is adopted to serve as the support body of the main body of the dry erase board, the weight of the dry erase board can be reduced greatly to make the dry erase board convenient to carry. The present application has a simple structure and strong practicality.

### BRIEF DESCRIPTION OF THE DRAWINGS

The present application will be further described with reference to the accompanying drawings and embodiments in the following, in the accompanying drawings:

FIG. 1 is a schematic view of a dry erase board of a first embodiment of the present application;

FIG. 2 is an exploded view of the dry erase board shown in FIG. 1;

FIG. 3 is a schematic view of the dry erase board of a second embodiment of the present application;

FIG. 4 is an exploded view of the dry erase board shown in FIG. 3;

FIG. 5 is a schematic view of a shackle of the dry erase board shown in FIG. 3;

FIG. 6 is a schematic view of the dry erase board of a third embodiment of the present application;

FIG. 7 is an exploded view of the dry erase board shown in FIG. 6;

FIG. 8 is a schematic view of the shackle of the dry erase board shown in FIG. 6.

### DETAILED DESCRIPTION OF THE PREFERRED EMBODIMENT

The technical problem that the present application will solve is that the size of an existing dry erase board is larger, the weight is heavier, and the dry erase board is usually fixed on a wooden support, which is not convenient to carry. The technical approach provided by the present application to solve the technical problem is adopting a corrugated paper board to serve as a support body of a main body of the dry erase board and then adopting a PVC adhesive tape and glue to edge seal the corrugated paper board, so that the corrugated paper board is hard to fold. Since the corrugated paper board is adopted to serve as the support body of the main body of the dry erase board, the weight of the dry erase board can be reduced greatly to make the dry erase board convenient to carry.

To make the technical feature and objective of the present application be understood more clearly, now the specific implementation of the present application is described in detail with reference to the accompanying drawings and embodiments.

### First Embodiment

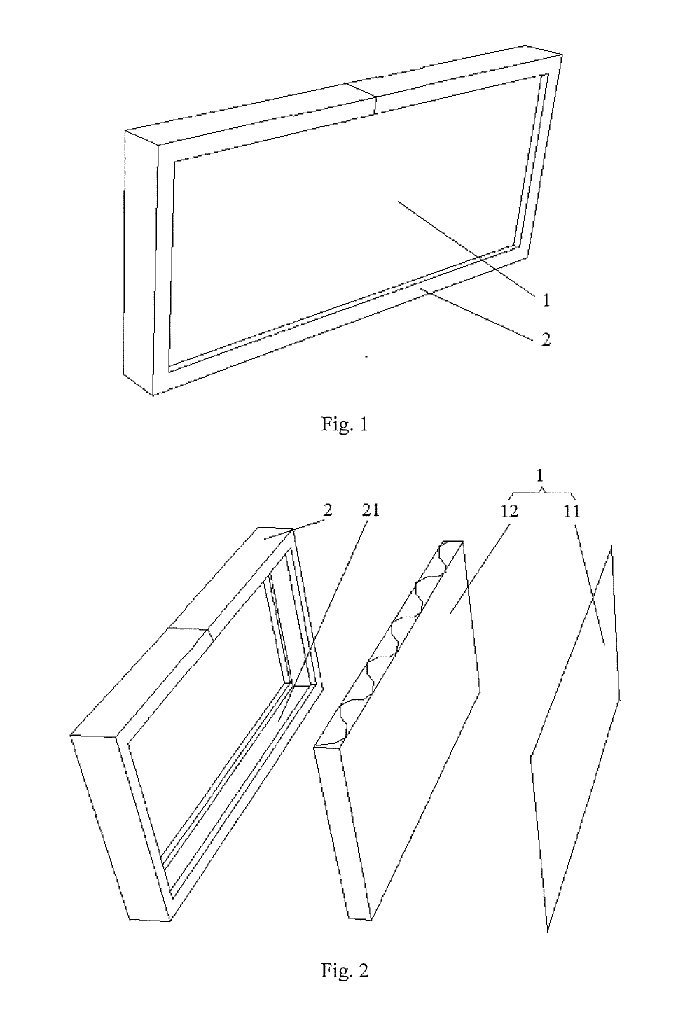

As shown in FIGS. 1 and 2, FIG. 1 is a schematic view of the dry erase board of a first embodiment of the present application, and FIG. 2 is an exploded view of the dry erase board shown in FIG. 1.

In FIG. 1, the dry erase board comprises a platy main body 1 and a PVC adhesive tape 2 mounted on the main body 1. Furthermore, in FIG. 2, the main body 1 includes a white board 11 and a corrugated paper board 12 affixed on a rear surface of the white board 11. In order to avoid the PVC adhesive tape 2 to be separated from the white board 11 caused by a force exerted on an end portion of the PVC adhesive tape 2, in the present embodiment, a fore end portion and an aft end portion of the PVC adhesive tape 2 are connected to each other to form a plastic frame via an adhesion agent.

The corrugated paper board 12 is formed by lamination of a smooth Kraft paper and a corrugated paper (i.e., Paper Core). Previously, a Kraft paper is partially or even entirely made of wood pulp, and has high burst strength and high supporting strength. However, in the past nearly twenty or thirty years, in order to satisfy the requirements of environment protection and cost, the content of wood pulp in the Kraft paper is reduced, waste paper is added to produce the Kraft paper, and the thickness of Kraft paper is thinner than before. As to the paper core, it is entirely recycled from waste paper.

The corrugated paper board 12 is easy to fold because of its structure. In the present embodiment, the PVC adhesive tape 2 is mounted on an edge portion of the corrugated paper board 12, so that the force applied to the dry erase board is dispersed by the PVC adhesive tape 2. Thus, the anti-fold capability of the dry erase board can be improved greatly, and the dry erase board will not be easy to fold because of the structure of the corrugated paper board 12.

In the present embodiment, an accommodating recess 21 is formed in an internal surface of the PVC adhesive tape 2, as shown in FIG. 2. An edge portion of the main body 1 is fastened in the accommodating recess 21. Moreover, the edge portion of the main body 1 is glued to a surface of the accommodating recess 21 of the PVC adhesive tape 2. In the present embodiment, the accommodating recess 21 exists and the main body 1 is glued to the surface of the accommodating recess 21, thus, the main body 1 can't be easily separated from the PVC adhesive tape 2.

Furthermore, the white board 11 may be a white organic glass panel or a white PVC panel.

### Second Embodiment

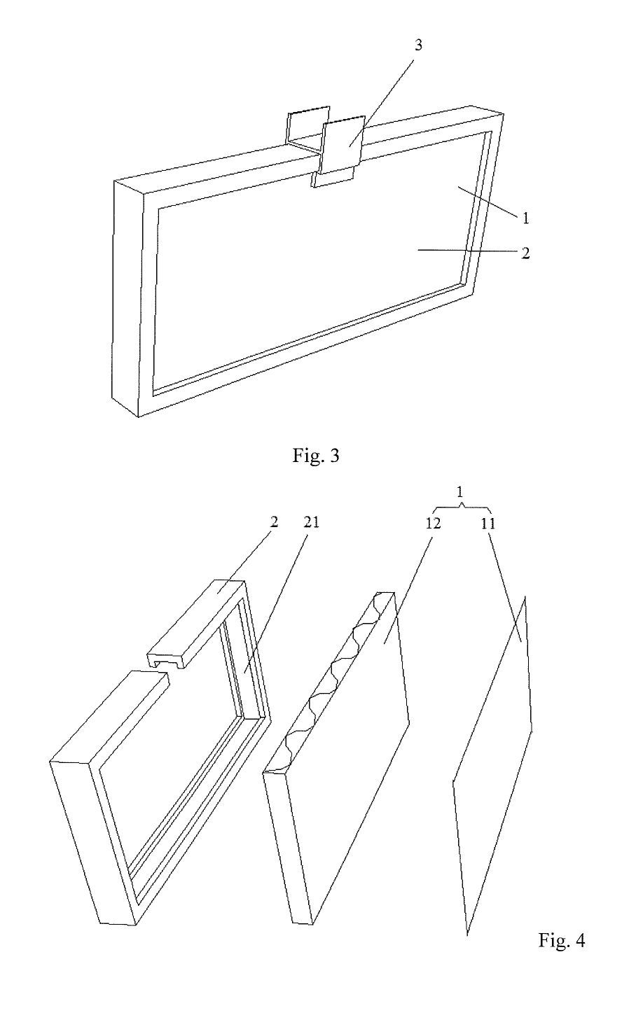

As shown in FIGS. 3 and 4, FIG. 3 is a schematic view of the dry erase board of a second embodiment of the present application, and FIG. 4 is an exploded view of the dry erase board shown in FIG. 3.

In FIG. 3, the dry erase board comprises a platy main body 1 and a PVC adhesive tape 2 mounted on the main body 1. Furthermore, in FIG. 4, the main body 1 includes a white board 11 and a corrugated paper board 12 affixed on a rear surface of the white board 11.

The corrugated paper board 12 is formed by lamination of a smooth Kraft paper and a corrugated paper (i.e., Paper Core). Previously, a Kraft paper is partially or even entirely made of wood pulp, and has high burst strength and high supporting strength. However, in the past nearly twenty or thirty years, in order to satisfy the requirements of environment protection and cost, the content of wood pulp in the Kraft papers is reduced, waste paper is added to produce the Kraft paper, and the thickness of Kraft paper is thinner than before. As to the paper core, it is entirely recycled from waste paper.

The corrugated paper board 12 is easy to fold because of its structure. In the present embodiment, the PVC adhesive tape 2 is mounted on an edge portion of the corrugated paper board 12, so that the force applied to the dry erase board is dispersed by the PVC adhesive tape 2. Thus, the anti-fold capability of the dry erase board can be improved greatly, and the dry erase board will not be easy to fold because of the structure of the corrugated paper board 12.

In the present embodiment, an accommodating recess 21 is formed in an internal surface of the PVC adhesive tape 2, as shown in FIG. 4. An edge portion of the main body 1 is fastened in the accommodating recess 21. Moreover, the edge portion of the main body 1 is glued to a surface of the accommodating recess 21 of the PVC adhesive tape 2. In the present embodiment, the accommodating recess 21 exists and the main body 1 is glued to the surface of the accommodating recess 21, thus, the main body 1 can't be easily separated from the PVC adhesive tape 2.

Furthermore, the white board 11 may be a white organic glass panel or a white PVC panel.

In the present embodiment, two end portions of the PVC adhesive tape 2 aren't glued together, thus, when the PVC adhesive tape 2 is mounted on the main body 1, a side surface of the corrugated paper board 12 of the main body 2 is exposed between the two end portions of the PVC adhesive tape 2, which leads to non-beauty and causes the main body 1 to damage easily. In order to avoid aforementioned situations from happening, in the present embodiment, the dry erase board further comprises a shackle 3. The shackle 3 is respectively shackled on the two end portions of the PVC adhesive tape 2, in such a way that the two end portions of the PVC adhesive tape 2 are connected to each other via the shackle 3.

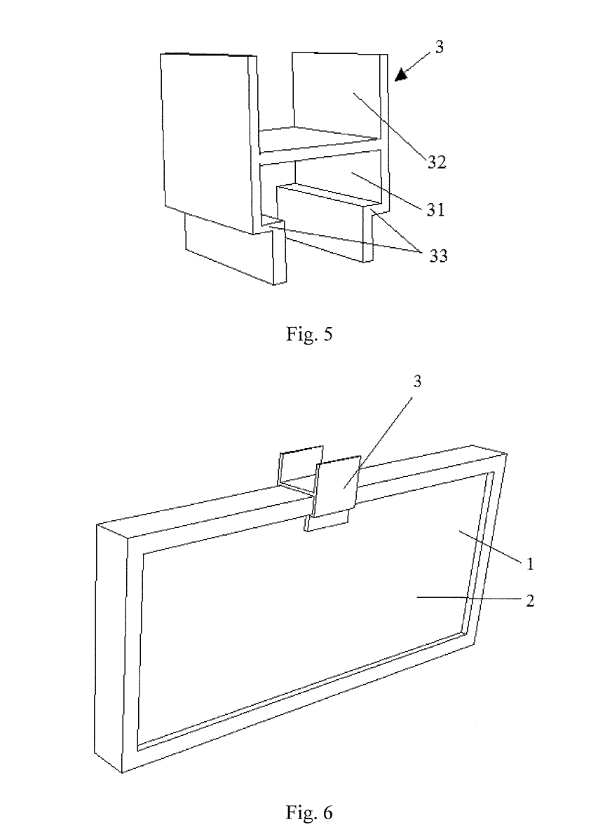

Generally, the dry erase board is used cooperatively with a dry erase board pen. Advantageously, in the present embodiment, as shown in FIG. 5, a cross section of the shackle 3 is H-shaped; and the shackle 3 has a bottom fixing recess 31 and a top fixing recess 32. Two fixing flanges 33 are respectively formed on two internal surfaces in the bottom fixing recess 31 of the shackle 3. The shackle 3 are respectively shackled on the two end portions of the PVC adhesive tape 2 via the bottom fixing recess 31 and the two fixing flanges 33. The PVC adhesive tape 2 is restricted by the two fixing flanges to prevent the shackle 3 from dropping down from the dry erase board. The dry erase board pen is detachably mounted in the top fixing recess 32 of the shackle 3.

### Third Embodiment

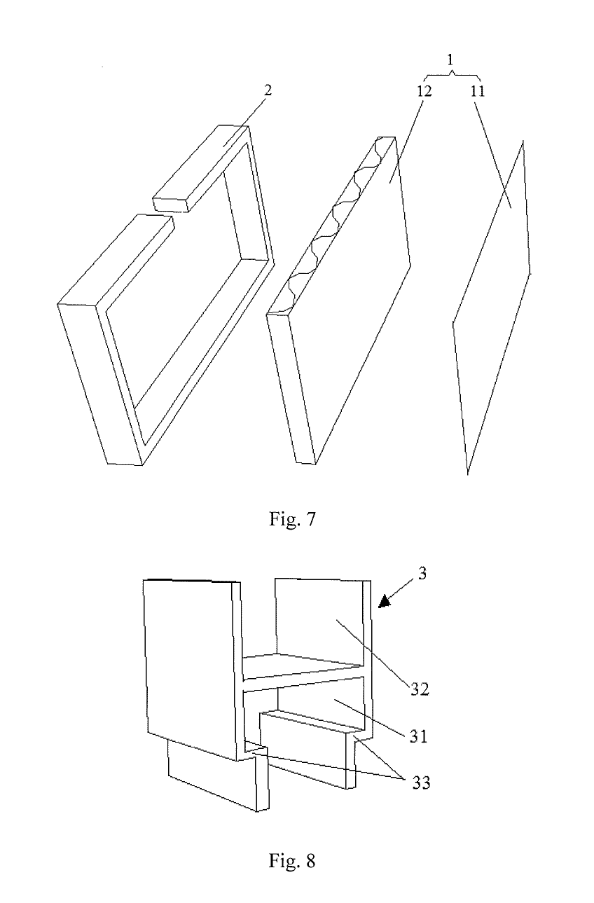

As shown in FIGS. 6 and 7, FIG. 6 is a schematic view of the dry erase board of a third embodiment of the present application; and FIG. 7 is an exploded view of the dry erase board shown in FIG. 6.

In FIG. 6, the dry erase board comprises a platy main body 1 and a PVC adhesive tape 2 mounted on the main body 1. Furthermore, in FIG. 7, the main body 1 includes a white board 11 and a corrugated paper board 12 affixed on a rear surface of the white board 11.

The corrugated paper board 12 is formed by lamination of a smooth Kraft paper and a corrugated paper (i.e., Paper Core). Previously, a Kraft paper is partially or even entirely made of wood pulp, and has high burst strength and high supporting strength. However, in the past nearly twenty or thirty years, in order to satisfy the requirements of environment protection and cost, the content of wood pulp in the Kraft paper is reduced, waste paper is added to produce the Kraft paper, and the thickness of Kraft paper is thinner than before. As to the paper core, it is entirely recycled from waste paper.

The corrugated paper board 12 is easy to fold because of its structure. In the present embodiment, the PVC adhesive tape 2 is mounted on an edge portion of the corrugated paper board 12, so that the force applied to the dry erase board is dispersed by the PVC adhesive tape 2. Thus, the anti-fold capability of the dry erase board can be improved greatly, and the dry erase board will not be easy to fold because of the structure of the corrugated paper board 12.

In the present embodiment, a cross section of the PVC adhesive tape 2 is line-shaped, as shown in FIG. 7. Furthermore, the white board 11 may be a white organic glass panel or a white PVC panel. In this case, there is no accommodating recess 21 defined in the PVC adhesive tape 2, which causes the white board 11 to be separated from the corrugated paper board 12 easily. Thus, in order to solve these problems, the white board 11 is glued to the corrugated paper board 12 via an adhesion agent in this case.

In the present embodiment, two end portions of the PVC adhesive tape 2 aren't glued together, thus, when the PVC adhesive tape 2 is mounted on the main body 1, a side surface of the corrugated paper board 12 of the main body 2 is exposed between the two end portions of the PVC adhesive tape 2, which leads to non-beauty and causes the main body 1 to damage easily. In order to avoid aforementioned situations from happening, in the present embodiment, the dry erase board further comprises a shackle 3. The shackle 3 is respectively shackled on the two end portions of the PVC adhesive tape 2, in such a way that the two end portions of the PVC adhesive tape 2 are connected to each other via the shackle 3.

Generally, the dry erase board is used cooperatively with a dry erase board pen. Advantageously, in the present embodiment, as shown in FIG. 8, a cross section of the shackle 3 is H-shaped; and the shackle 3 has a bottom fixing recess 31 and a top fixing recess 32. Two fixing flanges 33 are respectively formed on two internal surfaces in the bottom fixing recess 31 of the shackle 3. The shackle 3 are respectively shackled on the two end portions of the PVC adhesive tape 2 via the bottom fixing recess 31 and the two fixing flanges 33. The PVC adhesive tape 2 is restricted by the two fixing flanges 33 to prevent the shackle 3 from dropping down from the dry erase board. The dry erase board pen is detachably mounted in the top fixing recess 32 of the shackle 3.

The present application adopts the corrugated paper board to serve as a support body of a main body of the dry erase board and then adopts a PVC adhesive tape and glue to edge seal the corrugated paper board, in such a way that the corrugated paper board is hard to fold. Since the corrugated paper board is adopted to serve as the support body of the main body of the dry erase board, the weight of the dry erase board can be reduced greatly to make the dry erase board convenient to carry. The present application has a simple structure and strong practicality.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A dry erase board, comprising a platy main body and a PVC adhesive tape mounted on the main body, wherein the main body includes a white board and a corrugated paper board affixed on a rear surface of the white board; a fore end portion and an aft end portion of the PVC adhesive tape mounted on the main body are connected to each other to form a plastic frame.

2. The dry erase board according to claim 1, wherein the fore end portion and the aft end portion of the PVC adhesive tape are connected to each other via an adhesion agent.

3. The dry erase board according to claim 1, wherein the dry erase board further includes a shackle; the shackle is respectively shackled on the two end portions of the PVC adhesive tape, in such a way that the two end portions of the PVC adhesive tape are connected to each other via the shackle.

4. The dry erase board according to claim 3, wherein a cross section of the shackle is H-shaped, and the shackle has a bottom fixing recess and a top fixing recess configured for fastening a dry erase board pen; two fixing flanges are respectively formed on two internal surfaces in the bottom fixing recess of the shackle; the shackle are respectively shackled on the two end portions of the PVC adhesive tape via the bottom fixing recess and the two fixing flanges.

5. The dry erase board according to claim 1, wherein an accommodating recess is formed in an internal surface of the PVC adhesive tape, and an edge portion of the main body is fastened in the accommodating recess.

6. The dry erase board according to claim 1, wherein the white board is a white organic glass panel or a white PVC panel.
